(19) United States
(12) Patent Application Publication
(10) Pub. No.: US 2013/0321944 A1
(43) Pub. Date: Dec. 5, 2013

(54) SERVER AND METHOD FOR PREVENTING THE SERVER FROM VIBRATION DAMAGE

(71) Applicant: HON HAI PRECISION INDUSTRY CO., LTD., New Taipei (TW)

(72) Inventor: YU-CHEN HUANG, New Taipei (TW)

(73) Assignee: HON HAI PRECISION INDUSTRY CO., LTD., New Taipei (TW)

(21) Appl. No.: 13/900,582

(22) Filed: May 23, 2013

(30) Foreign Application Priority Data
May 29, 2012 (TW) 101119224

(51) Int. Cl. G11B 5/86

(52) U.S. Cl. CPC G11B 5/86
USPC 360/15

(57) ABSTRACT

In a method for preventing a server from a damage vibration, a first system log records detected vibration intensity of the server, and suspends a working operation of the hard disk if the detected vibration intensity of the server is greater than or equal to a predefined vibration intensity is determined. Data stored in the hard disk is copied to a solid-state drive (SSD) if the detected vibration intensity of the server is greater than or equal to the predefined vibration intensity, and an operating system of the server hibernates. The operating system of the server does not wake up until the detected vibration stops for a second predefined time period after the operating system of the server hibernates.

### BACKGROUND

1. Technical Field

Embodiments of the present disclosure relate to server protection systems and methods, and more particularly to a server and method for preventing the server from vibration damage.

2. Description of Related Art

When a server, such as a Container Data Center (CDC), is transported, vibration may be caused by uneven roads. The vibration may cause damage to a hard disk of the server. Therefore, it is needed to provide a method to decrease the damage to the hard disk of the server.

### BRIEF DESCRIPTION OF THE DRAWINGS

FIG. 1 is a block diagram of one embodiment of a server including a vibration prevention system.

FIG. 2 is a block diagram of one embodiment of function modules of the vibration prevention system in FIG. 1.

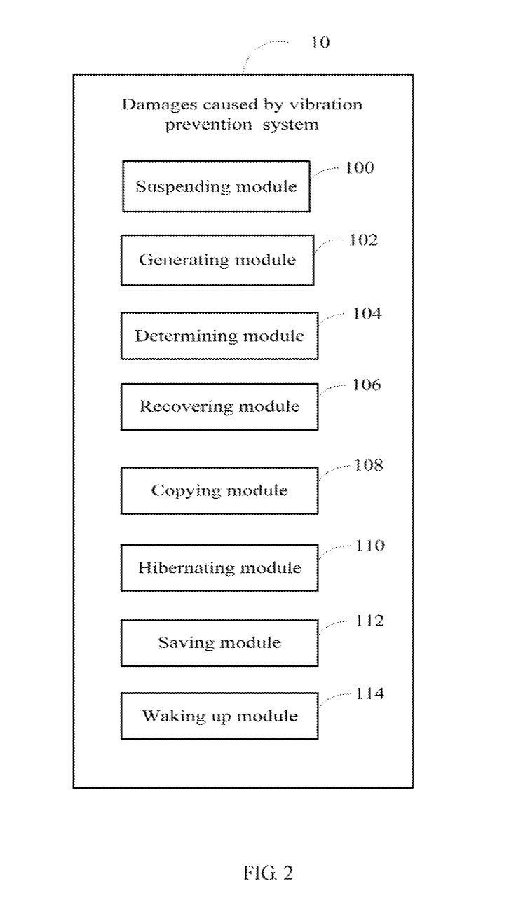

FIG. 3 is a flowchart of one embodiment of a method for preventing the server from vibration damage.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

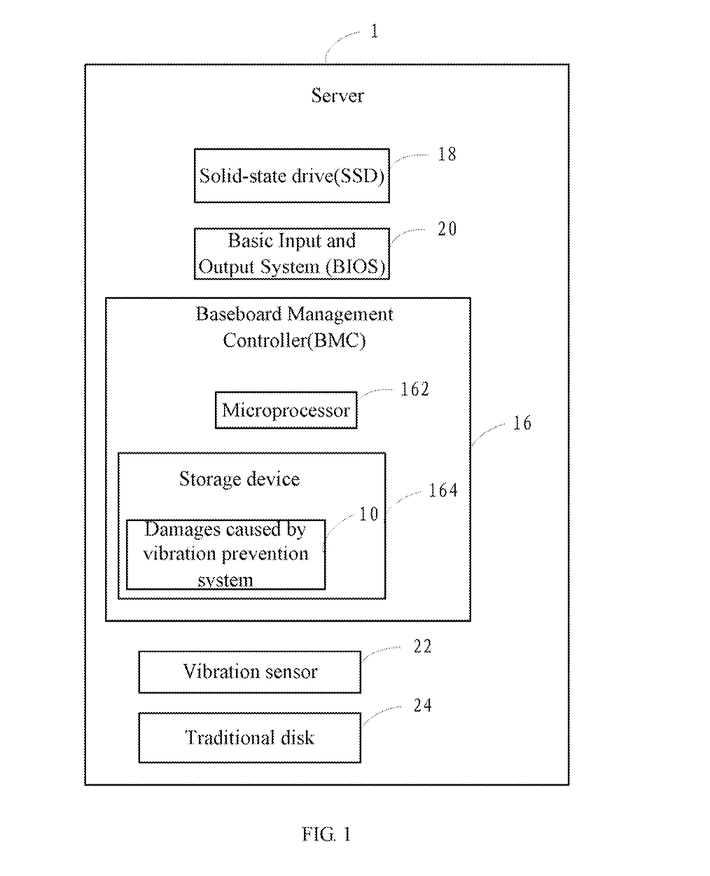

FIG. 1 is a block diagram of one embodiment of a server 1 including a vibration prevention system 10. In the embodiment, the server 1 comprises a Baseboard Management Controller (BMC) 16, a solid-state drive (SSD) 18, a Basic Input and Output System (BIOS) 20, a vibration sensor 22, and a hard disk 24. The server 1 may be a Container Data Center (CDC), for example.

The BMC 16 is a microcontroller on a motherboard of the server 1, and comprises a storage device 162 and at least one microprocessor 164.

In one embodiment, the storage device 162 (non-transitory storage device) may be an internal storage system, such as a random access memory (RAM) for the temporary storage of information, and/or a read only memory (ROM) for the permanent storage of information. In some embodiments, the storage device 162 may be an external storage system, such as an external hard disk, a storage card, or a data storage medium.

The at least one microprocessor 164 may include a processor unit, a microprocessor, an application-specific integrated circuit, and a field programmable gate array, for example.

The solid-state drive (SSD) 18 is (also known as a solid-state disk or electronic disk, though it contains no actual “disk” of any kind) is a data storage device using integrated circuit assemblies as memory to store data persistently. The SSD 18 may have no moving mechanical components, which distinguishes it from a traditional hard disk 24 such as a hard disk drive (HDD) or a floppy disk, which contain spinning disks and a movable read/write head. In the embodiment, the SSD 18 stores data copied from the traditional hard disk 24 to prevent a loss of the data copied from the traditional hard disk 24 after a hibernation of an operating system 10 of the server 1.

The BIOS 20 hibernates or wakes up an operating system of the server 1 using instructions of the BIOS 20 when the BIOS 20 receives a first or second system interrupt control signal from the BMC 16.

The vibration sensor 22 detects vibration of the server 1. The hard disk 24 is a traditional hard disk for storing data of the server 1. Vibration of the server 1 may be caused, for example, when the server 1 is moved, or during an earthquake, or during normal operations of the server 1.

In one embodiment, the vibration prevention system 10 includes a plurality of function modules which include computerized codes or instructions that can be stored in the storage device 162 and executed by the at least one processor 164 to provide a method for preventing the server from damage caused by vibration.

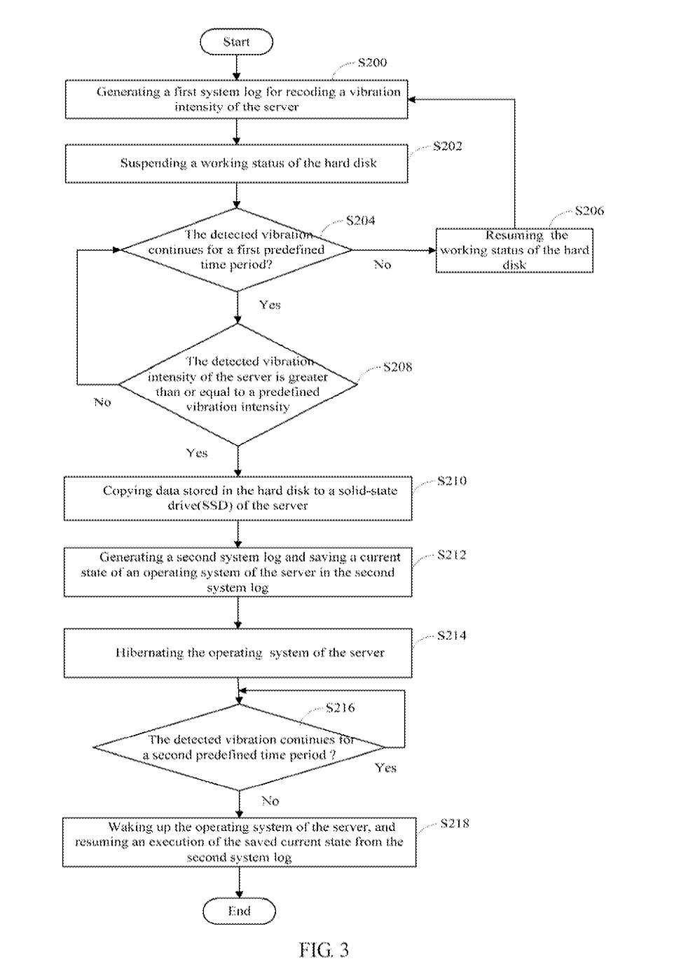

In one embodiment, the vibration prevention system 10 may include a generating module 100, a suspending module 102, a determining module 104, a recovering module 106, a copying module 108, a hibernating module 110, a saving module 112, and a waking up module 114. The modules may comprise computerized codes in the form of one or more programs that are stored in the storage device 162 and executed by the at least one processor 164 to provide functions for preventing the server from damages caused by vibration. The functions of the function modules are illustrated in FIG. 3 and described below.

FIG. 3 illustrates a flowchart of one embodiment of a method for preventing a server from a vibration damage. Depending on the embodiment, additional steps may be added, others removed, and the ordering of the steps may be changed.

In block S200, the generating module 100 generates a first system log recording a detected vibration intensity of the server 1 in real time when the vibration sensor 22 detects the vibration of the server 1. In the embodiment, the vibration intensity of the server 1 may be a vibration frequency or a vibration acceleration.

In block S202, the suspending module 102 suspends a working operation of the hard disk 24 to avoid a damage to the hard disk 24 caused by the vibration of the server 1.

In block S204, the determining module 104 determines whether the detected vibration continues for a first predefined time period such as 20 seconds. If the detected vibration continues for the first predefined time period, S208 is implemented. If the detected vibration does not continue for the first predefined time period, S206 is implemented.

In block S206, the recovering module 106 resumes the working status of the hard disk 24, and then returns S200.

In block S208, the determining module 104 determines whether the detected vibration intensity of the server 1 is greater than or equal to a predefined vibration intensity. In the embodiment, the predefined vibration intensity is a vibration intensity that may cause damage to data stored in the hard disk 24. If the detected vibration intensity of the server is greater than or equal to the predefined vibration intensity, S210 is implemented. If the detected vibration intensity of the server is not greater than or equal to the predefined vibration intensity, S204 is implemented.

In block S210, the copying module 108 copies the data stored in the hard disk 24 to the SSD 18.

In block S212, the saving module 110 generates a second system log and saves a current state of the operating system of the server 1 in the second system log.

In block S214, the hibernating module 112 hibernates the operating system of the server 1. In the embodiment, the hibernating module 112 generates a first system interrupt control signal and sends the first system interrupt control signal to the BIOS 20 to hibernate the operating system of the server 1.

In block S216, the determining module 104 determines whether the detected vibration continues for a second predefined time period after the system of the server 1 is hibernated. In the embodiment, the second predefined time period may be 30 s, for example.

If the detected vibration continues for a second predefined time period after the system of the server 1 is hibernated, the S216 is repeated. If the detected vibration does not continue for a second predefined time period after the system of the server 1 is hibernated, S218 is implemented.

In block S218, the waking up module 114 wakes up the operating system of the server 1, and resumes an execution of the saved current state from the second system log. In the embodiment, the waking up module 114 generates a second system interrupt control signal and sends the second system interrupt control signal to the BIOS to wake up the operating system of the server 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A server, comprising:
a solid-state drive (SSD);
a Basic Input and Output System (BIOS);
a vibration sensor;
a hard disk;
at least one microprocessor; and
a storage device storing a computer program including instructions that, which executed by the at least one microprocessor, causes the at least one microprocessor to perform a method, the method comprising steps:
(a) detecting vibration of the server using the vibration sensor;
(b) generating a first system log that records vibration intensity of the vibration in real time;
(c) suspending a working state of the hard disk;
(d) determining whether the detected vibration continues for a first predefined time period;
if the detected vibration continues for the first predefined time period, implementing step (f), or if the detected vibration does not continue for the first predefined time period, implementing step (e);
(e) recovering the working state of the hard disk, and then returning to step (a);
(f) determining whether the detected vibration intensity of the server is greater than or equal to a predefined vibration intensity;
if the detected vibration intensity of the server is greater than or equal to the predefined vibration intensity, implementing step (g), or if the detected vibration intensity of the server is not greater than or equal to the predefined vibration intensity, implementing step (d);
(g) copying data stored in the hard disk to the SSD;
(h) hibernating an operating system of the server;
(i) determining whether the detected vibration continues for a second predefined time period after the operating system of the server hibernates;
if the detected vibration continues for the second predefined time period after the operating system of the server hibernates, repeating step (i); or if the detected vibration does not continue for the second predefined time period after the operating system of the server hibernates, implementing step (j); and
(j) waking up the operating system of the server.

2. The server according to claim 1, wherein the predefined vibration intensity is a vibration intensity that causes damage to the data stored in the hard disk.

3. The server according to claim 1, wherein (i) comprises:
generating a first system interrupt control signal and sending the first system interrupt control signal to the BIOS to hibernate the operating system of the server.

4. The server according to claim 1, wherein (j) comprises:
generating a second system interrupt control signal and sending the second system interrupt control signal to the BIOS to wake up the operating system of the server.

5. The server according to claim 1, wherein the method further comprises:
generating a second system log and saving a current state of the operating system of the server in the second system log before (h).

6. The server according to claim 5, wherein the method further comprises:
resuming an execution of the saved current state from the second system log after the step (j).

7. A method for preventing a server from vibration damage, the method comprising:
(a) detecting vibration of the server using a vibration sensor of the server;
(b) generating a first system log that records vibration intensity of the vibration in real time;
(c) suspending a working state of a hard disk of the server;
(d) determining whether the detected vibration continues for a first predefined time period;
if the detected vibration continues for the first predefined time period, implementing step (f), or if the detected vibration does not continue for the first predefined time period, implementing step (e);
(e) recovering a working state of the hard disk, and then returning to step (a);
(f) determining whether the detected vibration intensity of the server is greater than or equal to a predefined vibration intensity;
if the detected vibration intensity of the server is greater than or equal to the predefined vibration intensity, implementing step (g), or if the detected vibration intensity of the server is not greater than or equal to the predefined vibration intensity, implementing step (d);
(g) copying data stored in the hard disk to a solid-state drive (SSD) of the server;
(h) hibernating an operating system of the server;
(i) determining whether the detected vibration continues for a second predefined time period after the operating system of the server hibernates;
if the detected vibration continues for the second predefined time period after the operating system of the server hibernates, repeating step (i); or if the detected vibration does not continue for the second predefined time period after the operating system of the server hibernates, implementing step (j); and
(j) waking up the operating system of the server.

8. The method according to claim 7, wherein the predefined vibration intensity is a vibration intensity that cause a damage to the data stored in the hard disk.

9. The method according to claim 7, wherein (i) comprising:
generating a first system interrupt control signal and sending the first system interrupt control signal to a Basic Input and Output System (BIOS) of the server to hibernate the operating system of the server.

10. The method according to claim 7, wherein (j) comprising:
generating a second system interrupt control signal and sending the second system interrupt control signal to the BIOS to wake up the operating system of the server.

11. The method according to claim 7, wherein the method further comprising:
generating a second system log and saving a current state of the operating system of the server in the second system log before (h).

12. The method according to claim 11, wherein the operation further comprising:
resuming an execution of the saved current state from the second system log after (j).

13. A non-transitory computer-readable storage medium having stored thereon instructions being executed by a processor of a server, causes the server to perform a method for preventing the server from a vibration damages, the method comprising:
(a) detecting vibration of the server using a vibration sensor of the server;
(b) generating a first system log that records vibration intensity of the vibration in real time;
(c) suspending a working state of a hard disk of the server;
(d) determining whether the detected vibration continues for a first predefined time period;
if the detected vibration continues for the first predefined time period, implementing step (f), or if the detected vibration does not continue for the first predefined time period, implementing step (e);
(e) recovering a working state of the hard disk, and then returning to step (a);
(f) determining whether the detected vibration intensity of the server is greater than or equal to a predefined vibration intensity;
if the detected vibration intensity of the server is greater than or equal to the predefined vibration intensity, implementing step (g), or if the detected vibration intensity of the server is not greater than or equal to the predefined vibration intensity, implementing step (d);
(g) copying data stored in the hard disk to a solid-state drive (SSD) of the server;
(h) hibernating an operating system of the server;
(i) determining whether the detected vibration continues for a second predefined time period after the operating system of the server hibernates;
if the detected vibration continues for the second predefined time period after the operating system of the server hibernates, repeating step (i); or if the detected vibration does not continue for the second predefined time period after the operating system of the server hibernates, implementing step (j); and
(j) waking up the operating system of the server.

14. The storage medium according to claim 13, wherein the predefined vibration intensity is a vibration intensity that cause a damage to the data stored in the hard disk.

15. The storage medium according to claim 13, wherein (i) comprising:
generating a first system interrupt control signal and sending the first system interrupt control signal to a Basic Input and Output System (BIOS) of the server to hibernate the operating system of the server.

16. The storage medium according to claim 13, wherein (j) comprising:
generating a second system interrupt control signal and sending the second system interrupt control signal to the BIOS to wake up the operating system of the server.

17. The storage medium according to claim 13, wherein the method further comprising:
generating a second system log and saving a current state of the operating system of the server in the second system log before (h).

18. The storage medium according to claim 17, wherein the method further comprises:
resuming an execution of the saved current state from the second system log after (j).
